(19) United States
(12) Patent Application Publication
(10) Pub. No.: US 2007/0241244 A1
(43) Pub. Date: Oct. 18, 2007

(54) Method and apparatus for eliminating keyhole problems in an X-Y gimbal assembly

(75) Inventor: Behzad Tavassoli Hozouri, Santa Clara, CA (US)

Correspondence Address: INTELLECTUAL PROPERTY LAW OFFICES, 1901 S. BASCOM AVENUE, SUITE 660, CAMPBELL, CA, 95008, US

(73) Assignee: X-Ether, Inc.

(21) Appl. No.: 11/405,892

(22) Filed: Apr. 18, 2006

(51) Int. Cl. F16M 11/14

(52) U.S. Cl. 248/183.1

(57) ABSTRACT

The present invention provides an X-Y gimbal that eliminates the keyhole problem—a problem which occurs when a payload mounted on the X-Y gimbal is required to be pointed at a direction which is close to co-linear to the gimbal's Y axis. The preferred embodiment provides for a rotation around the Z axis of both the X and Y gimbals as the target approaches a predetermined proximity to co-linearity with the Y axis. An alternate embodiment provides for a predetermined tilting of the Y axis gimbal. Both inventive embodiments provide uninterrupted and continuous tracking of a target without expensive electric and/or electromagnetic energy transferring slip-rings and rotary joints.

### RELATED APPLICATIONS

Not applicable.

### GOVERNMENT FUNDING

Not Applicable.

### FIELD OF USE

This invention relates to a gimbal system, and in particular to an X-Y gimbal system that provides continuous tracking and lock-free performance.

### BACKGROUND

A gimbal—a device consisting of a pair of orthogonal rotators—is used for supporting and orienting a payload on a platform independently of platform orientation. A payload may be, for example, an antenna. Excluding the motors and microprocessors and the relevant electrical/electronic circuitries and devices (which are not depicted), FIG. 1 depicts a gimbal system 10 for an antenna payload 55; such a system includes a pedestal 35 (base; a bottom support for a rotator), and a pair of orthogonal rotators (X axis rotator 15 and Y axis rotator 25). The rotator pair is commonly denominated a “gimbal”, from the French, gemelle, meaning “twin”.

Gimbal systems have various applications often determined by the nature of the payload. For example, a gimbal system can be used for stabilizing and aiming an antenna on a moving ship (or flying aircraft) toward a satellite for telecommunication purposes, i.e., transmitting and/or receiving electrical signals.

Payloads such as antennas are ideally in constant, uninterrupted orientation with the signal source. As either the target, the platform, or both are in constant motion, the gimbal may be adjusted by associated motors so as to ensure the payload continuous and uninterrupted tracking of the source. However, certain conditions, such as “gimbal lock”, prevent continuous tracking.

“Gimbal lock” occurs when the gimbal system reaches the limits of the system's ability to continuously move and track. A gimbal system mount is basically a mounting frame having two orthogonal axes of rotation. Physical constraints in the rotation of the mount gives rise to so-called “locks”: positions where the mount can rotate no further. “Gimbal lock”—also sometimes referred to as “keyhole” or “zone of occlusion”—applies to a two-axis rotating system.

One widely used type of gimbal is known as the azimuth-elevation gimbal (hereinafter abbreviated “AZ-EL”). An AZ-EL is capable of rotating in two directions. The first rotational direction is in an azimuth direction which involves rotation of the payload in a turntable motion in order to track the azimuth angle of a target.

The second rotational direction is in the elevation direction which occurs by rotating the structure according to an elevation angle of a target. The keyhole problem in an AZ-EL gimbal system occurs when the payload is tracking a “relatively moving target” (hereinafter abbreviated “RMT”), such as a satellite, near its zenith position. When the RMT is directly overhead, the AZ-EL system will stop tracking at zenith because at this point the azimuth angle after zenith is 180 degrees different from the azimuth angle immediately prior to zenith. To continue tracking, the azimuth motor must turn the payload nearly 180 degrees as quickly as possible to continue tracking the RMT as it crosses the zenith position. Nevertheless, however brief, it is some non-zero time for even the fastest motor to turn the payload 180 degrees, and during that time the RMT is out of continuous contact with the payload.

Some solutions to the zenith keyhole in AZ-EL gimbal systems have been described in U.S. Pat. No. 6,285,338 (Bai et al.) and U.S. Pat. No. 6,853,349 (Chishinski ). A full description of the problem of gimbal lock in AZ-EL gimbals may be found in U.S. Pat. No. 6,285, 338 (Bai et al.), incorporated by reference as if fully set forth herein.

An advantage of the AZ-EL gimbal is it's substantially small sweep volume which allows for an overall small antenna structure. However for many applications where the payload is some type of electronic or communication device system, e.g., antenna pointing applications, an AZ-EL gimbal system is very expensive because a radio frequency—or even microwave frequency—single or multiple-channel rotary joints and/or slip-rings are required to enable the gimbal to rotate continuously. Such rotary joints and slip-rings can be prohibitively expensive. This is particularly true in applications such as projectile guidance where the gimbal system is essentially a “single use” system. A less expensive gimbal system is sought that is capable of continuous tracking and providing high performance, and also a system in which the keyhole problem has been solved.

Another type of gimbal system is known as the X-Y type, which has been referred to by a variety of terms, including: X over Y; cross elevation over elevation; traverse over elevation; cross level over elevation. An X-Y gimbal system has the ability to rotate about the X and Y axes which are substantially orthogonal to each other and not necessarily coplanar.

Referring to FIG. 1, the depicted X-Y gimbal system 10 has two rotatable axes: X 15, and Y 25. Pig 1 depicts a basic X-Y gimbal supporting a payload 55 (in this instance, the payload is an antenna). The payload 55 is directly attached to X-axis mount 45 that is coupled to the Y-axis mount 46. The Y-axis mount is in turn supported by a base 35. The rotation around any axis is equal to or less than 180 degrees and equal to or more than zero degrees.

Basic X-Y gimbals have a typically large sweep volume and, thus, are typically large in size for a given payload size. Using proper configurations, it is possible to design X-Y gimbals that require the same volume as a traditional AZ-EL design.

One of the main advantages of the X-Y pedestal is that it does not have the keyhole problem at or near its zenith position. Another advantage is that it does not require expensive electric and/or electromagnetic energy transferring rotary joints or slip-rings for its main rotations, even for continuous 360 degrees rotation in azimuth.

It should be noted that a basic X-Y pedestal of FIG. 1 is still not capable of full hemispherical tracking. Unlike an AZ-EL gimbal type that is unable to continuously track high elevation passes, the X-Y gimbal type has its limitations at low elevation angles (e.g., approximately at or near 4 degrees from the horizon for satellite communication antennas), at around 90° and 270° in azimuth.(i.e., the two directions of the Y axis), depicted in FIG. 1b as a first zone of discontinuity 6 and a second zone of discontinuity 7.

One typical instance of gimbal lock in an X-Y gimbal is illustrated in FIG. 2. As can be seen in FIG. 2, the payload 55 has rotated 180 degrees around the Y axis 25 and nearly 180 degrees around the X axis 15. The target 60 is in motion relative to the payload 55. (Such “relative movement” in the target—or “relatively moving target” (RMT)—is depicted by three positions of the target 60, A, B and C in FIG. 2, FIG. 3 and FIG. 4, such that “A” represents a first position, “B” represents a second position, and “C” represents a third position. The arrows indicate the direction of movement of the target 60.)

As can be seen in FIG. 2, when the target 60 moves from A to C, the path of the target crosses a point close to the Y axis at a point B 62 (depicted on line 22, where line 22 is parallel to the Y axis 25). Because the gimbal cannot turn more than 180 degrees around the X axis 15—i.e., through its own axis center—so as to continue tracking the target 60 as it passes from A to C, the gimbal must perform a rotation of 180 degrees (a counter-clockwise rotation) around the Y axis 25 if it is to continue tracking the target 60. Because any physical rotation cannot be instantaneous but rather must take some amount of time, however small, a discontinuity in tracking will occur. For some 4 non-zero period of time, the payload 55 will be out of connection with the target 60.

As has been pointed out previously, discontinuities in tracking occur at all the points in a zone around each of the two directions of the Y axis (i.e., 90 and 270 degrees azimuth) shown as a first zone of discontinuity 6 and a second zone of discontinuity 7 in FIG. 1b respectively.

The nature of this low elevation angle tracking discontinuity in an X-Y gimbal system may be understood as essentially identical to that of zenith keyhole for AZ-EL gimbals. In other words, the zenith keyhole may be thought of as having been translocated from 90 degrees zenith to two locations on the horizon. This means that any target anywhere in the hemisphere can be tracked without difficulty above a non-zero, small elevation angle (e.g., approximately 4 degrees for satellite communication antennas).

However, as discussed herein above, two discontinuity zones (see FIGS. 1b 6 and 7) exist on the horizon at angles equal or below a specific value away from the Y axis direction(s), e.g., usually in the neighborhood of 4 degrees for satellite communication antennas. Although incomplete (discontinuous) hemispherical coverage may be tolerable for some applications, full hemispherical coverage for tracking performance is essential in applications such as, for example, airborne or seaborne satellite communication.

One approach to attaining full hemispheric coverage has been to use a combination of X-Y and AZ-EL so that if the elevation angle is less than a predetermined value, the system will act as an AZ-EL type and otherwise as an X-Y type. However, this approach requires electric and/or electromagnetic energy transferring rotary joints and/or slip-rings in order to provide full circle tracking within low elevation angles. Given the increase in cost in a gimbal system requiring electromagnetic energy transferring rotary joints and/or slip rings, such a system sacrifices low cost—one of the main advantages of X-Y gimbals.

Accordingly, a need exists for an improved method and apparatus for alleviating the keyhole problem associated with X-Y gimbal systems. What is needed is an X-Y gimbal system for a payload designed for tracking a RMT where the design does not substantially increase the sweep volume and overall size and where the system may be manufactured at a low cost, e.g., no electric and/or electromagnetic energy transferring rotary joints or slip-rings required. What is further needed is an X-Y gimbal system capable of continuous tracking where the quality of the connection with that being tracked is consistently high.

### SUMMARY OF THE INVENTION

The invention provides an improved X-Y gimbal system that provides continuous full hemispheric coverage without gimbal lock. The invention further provides an X-Y gimbal system wherein the manufacturing cost is relatively low, as the inventive system does not require electric and/or electromagnetic energy transferring rotary joints or slip-rings. The invention also provides an X-Y gimbal system capable of continuous tracking where the quality of the connection with that being tracked is consistently high.

In a first embodiment of the invention, an X-Y gimbal system accomplishes uninterrupted tracking by rotating the X and Y axes around the Z axis at some point when it is predicted that entrance of the target (the RMT) into a discontinuity zone is imminent. It is understood that for an X-Y gimbal system, small elevation angles, e.g., at or near approximately 4 degrees for satellite communication antennas, are vulnerable to being zones of discontinuity. Herein, the term zone of discontinuity is meant to refer to any angle that is considered within the zone of discontinuity under the conditions of the gimbal system (size, weight, motor size, speed of target, etc.). In some instances, the range of elevation angles near 4 degrees for satellite communication antennas is discussed, but it should be understood that this invention is not to be limited by any specific angle or any payload type, as the invention applies in any condition where continuity is at risk.

In a second embodiment of the invention, the X-Y gimbal system (as described hereinabove) accomplishes uninterrupted tracking by tilting the Y axis up or down when an RMT's entrance into a discontinuity zones is predicted to be imminent. The tilt could be equal to or more than the maximum angle included by the discontinuity zone. Simply being equal to the maximum angle of the zone of discontinuity effectively overcomes gimbal lock and sustains continuity of tracking an RMT.

In both the preferred and alternate embodiments, a single or a small number of predetermined rotation steps will be needed, in clockwise and counterclockwise directions, thereby obviating the need for a continuous rotation (and avoiding cable wrap up, etc.) for any tracking scenario.

Although the figures depict the payload as an antenna, and the discussion refers to angles germane to communication satellite antennas, the inventive gimbal system is adaptable for any payload.

### BRIEF DESCRIPTION OF THE DRAWINGS

FIG. 1 a shows an isometric view of a known basic X-Y gimbal.

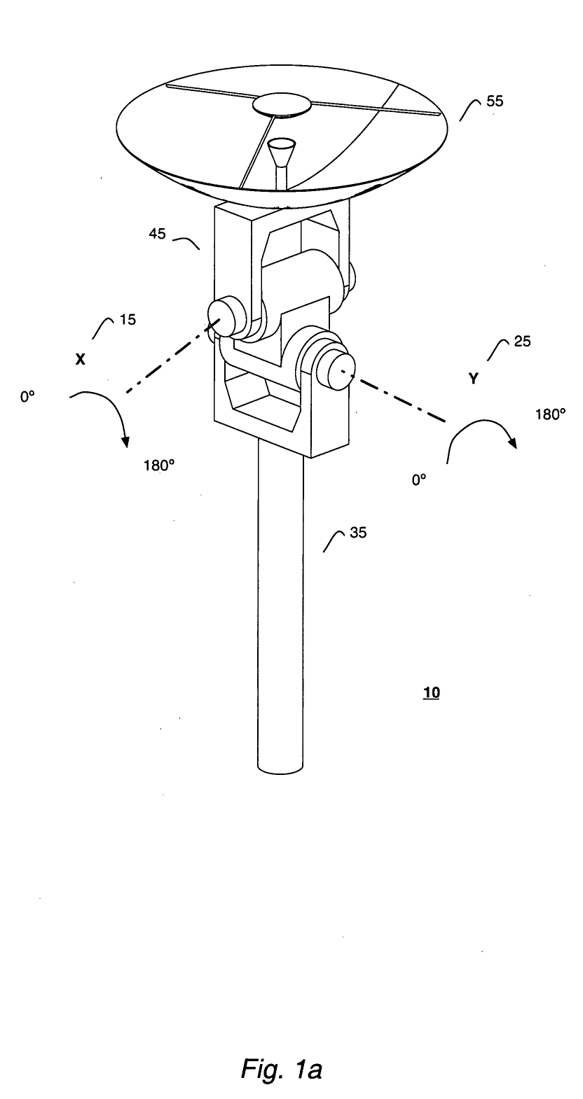

FIG. 1b depicts the zones of discontinuity for an X-Y gimbal as in FIG. 1a.

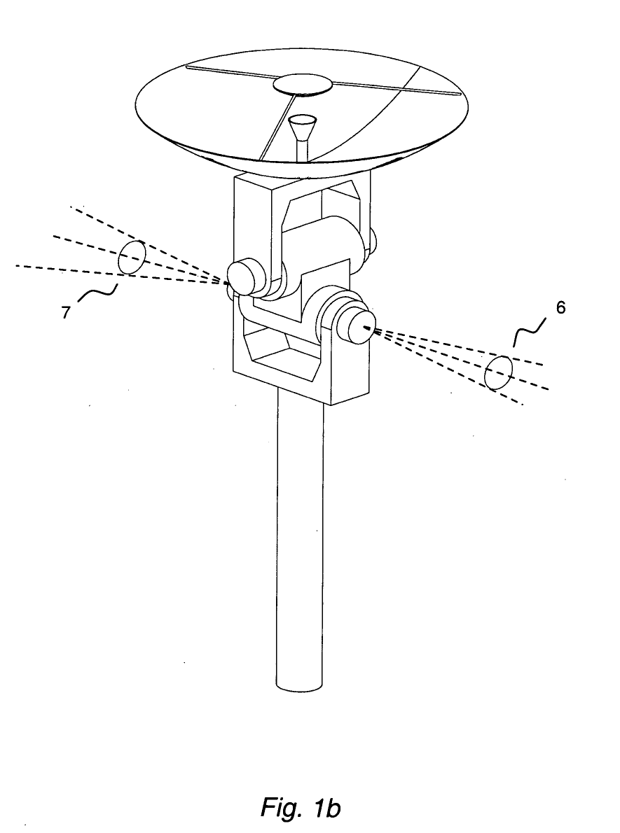

FIG. 2 shows a typical keyhole situation for a known basic X-Y gimbal.

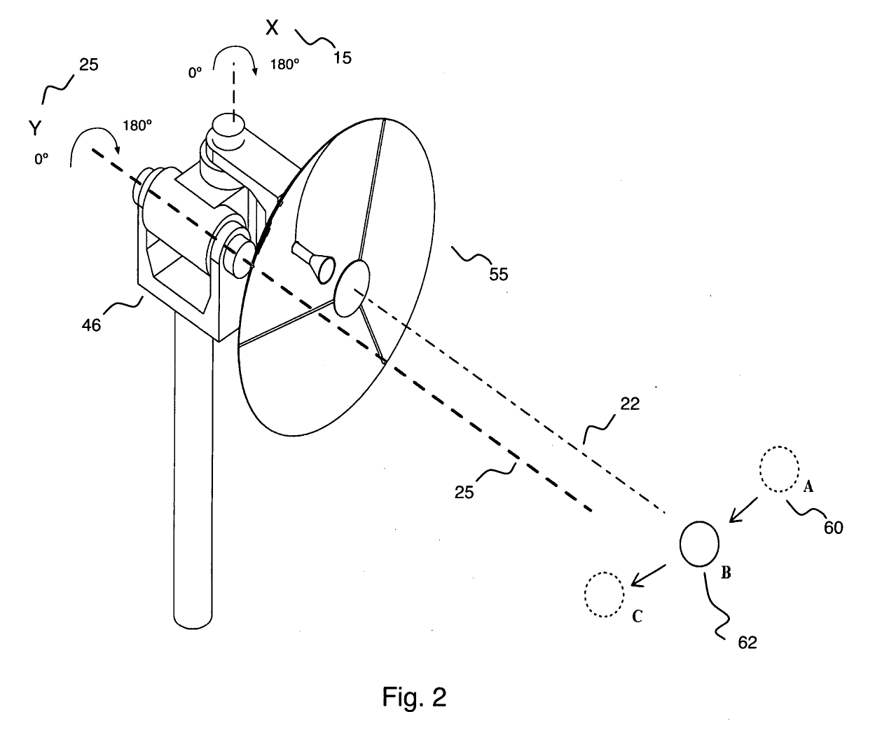

FIG. 3 shows an isometric view of the modified X-Y gimbal system according to a first embodiment of the invention.

FIG. 4 shows an isometric view of the modified X-Y gimbal system according to an alternate embodiment of the invention.

### DETAILED DESCRIPTION OF THE PREFERRED EMBODIMENTS

The present invention provides two alternate embodiments of an X-Y gimbal system capable of providing full hemispheric coverage, i.e., avoiding the keyholes on the horizon without requiring the use of electric and/or electromagnetic energy transferring slip-rings or rotary joints. The elements are numbered consistently in the drawings (for example, “payload” is 55 in all figures). The figures are to aid in the understanding of the invention; it must be understood that components such as software, motors, or other components are not depicted as the use and function of such components are well understood by one of average skill in the relevant art.

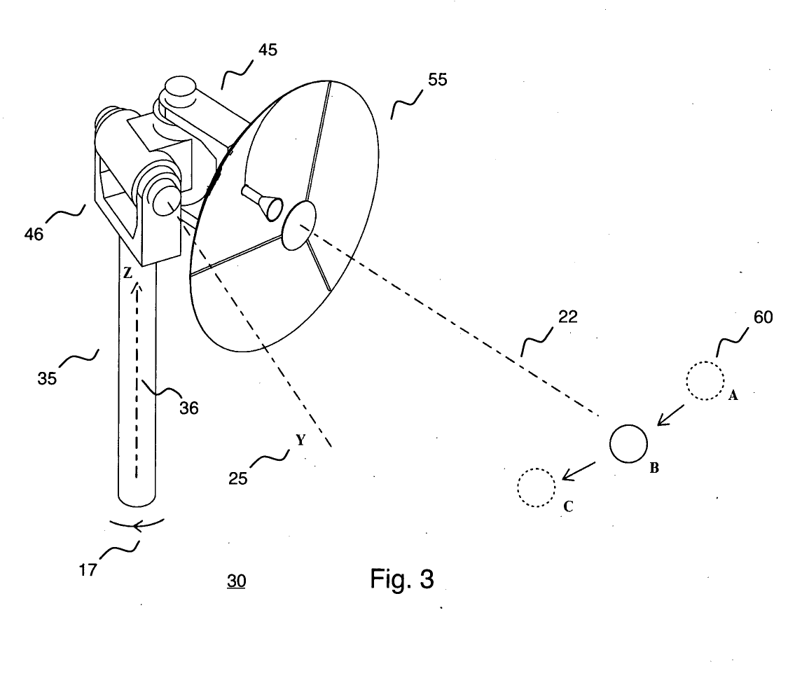

An inventive system according to the preferred embodiment, as illustrated in FIG. 3, includes providing rotation 17 of the gimbal system 30 around the Z axis 36 which is perpendicular to the X and Y axes and passes through the center of the gimbal mount 35, whenever the payload 55 approaches points within a zone of discontinuity. Therefore, by means of the rotation of the Z axis 36, the direction of the payload 55 will be changed by a predetermined angle; the precise angle depends on various parameters including—to name a few—the payload's mechanical characteristics, the payload's electrical characteristics, and the power of motors that are used in the gimbal system.

The rotation 17 of the Z axis 36 maybe performed as a single step. Alternatively, the rotation may be a combination of rotations, the first rotation of which is in the direction of travel of the target. “Target”, as used herein, should be understood to mean anything at which the payload is aimed or otherwise in predetermined relative orientation.

If the target continues to move, additional rotations in the direction of the travel path may be made. However, to avoid cable wrap up and to lessen the chance of full rotation, as soon as the target is safely away from entering a zone of discontinuity, one or more reverse rotations can be made. The reverse rotation can restore the gimbal to the initial state—the condition prior to the first rotation of the Z axis.

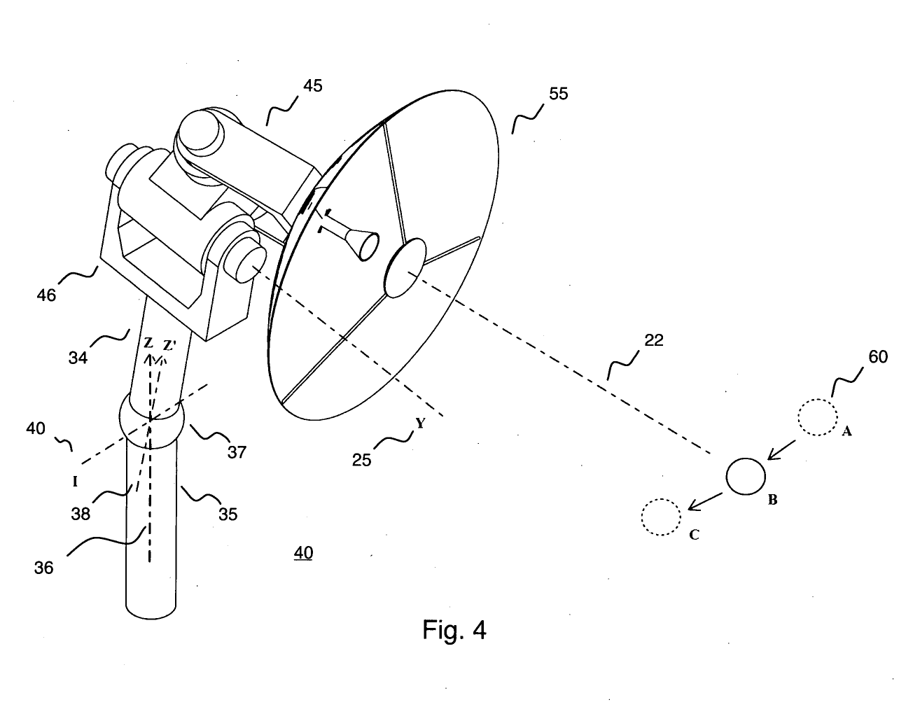

The second approach and alternate embodiment, which is depicted in FIG. 4, can be implemented by tilting up or down the Y axis around the horizontal line, here shown by I, orthogonal to the Y axis so that the keyhole lock (the zone of discontinuity) will be below the horizon. FIG. 4 depicts a downward tilt (“down” as used herein means a tilt toward the base of the gimbal), as can be seen by comparing Z 36 with Z 38. The tilt is enabled by a joint 37 at a point below the Y mount. The portion between the joint and the Y mount 34 is shown as having some length The gimbal design could position the joint 37 at any point in or below the Y mount, in any such design as best meets conditions under which the gimbal is intended to function.

As depicted in FIG. 4 such a downward tilt effectively positions the target 60 away from the Y axis by a sufficient angle so as to prevent gimbal lock (e.g., at or within a few degrees of approximately 4 degrees form the horizon for satellite communication antennas). An upward tilt under appropriate circumstances should also be understood to provide the desired result.

The invention teaches the payload orientation relative to the target can be maintained continuously by proper rotations of X and/or Y axes, thereby providing continuous tracking. After the payload is pointed to a point away from a keyhole zone (no longer imminently approaching a zone of discontinuity), the rotations taught by this invention can be reversed. Periodic rotation reversal prevents cable wrap-up and avoids the “adding up” of the rotations which might result in continuous 360 degrees rotation in azimuth.

The rotations needed for the embodiments described herein can be accomplished using a motor or even a linear actuator at any point beneath the Y axis. Such motors or actuators are not depicted, as the person of average skill will be familiar with them. Moreover, the software capable of predicting the entrance of a target into a zone of discontinuity is also familiar to one of average skill in the relevant art.

While the invention has been described in conjunction with specific embodiments thereof, many alternatives, modifications and variations will be apparent to those of ordinary skill in the art in light of the foregoing description. Accordingly, the invention is intended to embrace all such alternatives, modifications and variations as fall within the broad scope of the appended claims.

I claim:

1. An X-Y gimbal system for orienting a payload, said system comprising:
a support for said payload;
a mount for said support, said mount comprising:
a gimbal structure for supporting said payload, said gimbal structure including an X axis rotatable structure and a Y axis rotatable structure and a Z axis rotatable structure, wherein the orientation of the payload is different than the orientation of at least one of the X axis and Y axis rotatable structures;
a first mechanism for changing an orientation of said payload by rotation around said X axis rotatable structure;
a second mechanism for changing orientation of said payload by rotation around said Y axis rotatable structure;
a third mechanism for changing orientation of said payload by rotation around said Z axis rotatable structure; and
a control mechanism for controlling said first mechanism, said second mechanism and said third mechanism so as to coordinate rotation around said X axis, said Y axis, and said Z axis.

2. A system as in claim 1 further including a means for changing the effective angle of inclination of the payload and a control mechanism to coordinate said effective angle of inclination changes along with rotations around said X axis, said Y axis, and said Z axis.

3. A system as in claim 2 wherein the rotations around said X axis and Y axis and Z axis may be in either rotational direction.

4. A system as in claim 3 wherein the payload may be oriented toward a RMT (relatively moving target) and wherein the control mechanism operates to adjust the rotation around at least one axis so that the payload is continuously oriented towards said RMT.

5. A system as in claim 4 wherein the control mechanism operates to adjust rotations in clockwise and counterclockwise directions, in such a manner as to avoid cable wrap-up.

6. A system as in claim 5 wherein the control mechanism may cause a first rotation of the payload around at least one axis, said rotation being in the direction in which a target is traveling, and said rotation timed so that the payload is in continuous contact with the target.

7. A system as in claim 6 wherein the control mechanism may cause at least one rotation in the reverse direction of the first rotation.

8. A system as in claim 7 wherein the first rotation and the reverse rotation are timed relative to a probable target path toward or away from a zone of discontinuity.

9. An X-Y gimbal system for orienting a payload, said system comprising:
a support for said payload;
a mount for said support, said mount comprising:
a gimbal structure for supporting said payload, said gimbal structure including an X axis rotatable structure and a Y axis rotatable structure and a Z axis rotatable structure, and a base for the gimbal structure and a tiltable joint between the base and the payload, wherein the orientation of the payload is different than the orientation of at least one of the X axis and Y axis rotatable structures;
a first mechanism for changing an orientation of said payload by rotation around said X axis rotatable structure;
a second mechanism for changing orientation of said payload by rotation around said Y axis rotatable structure;
a third mechanism for changing orientation of said payload by rotation around said Z axis rotatable structure;
a fourth mechanism for changing the orientation of said payload by tilting around said tiltable joint structure; and
a control mechanism for controlling said first mechanism, said second mechanism, said third mechanism, and said fourth so as to coordinate rotation around said X axis, said Y axis, and said Z axis and said tiltable joint.

10. A method of aiming a payload mounted on a support in a certain direction, said method comprising:
a) providing a structure for aiming the payload, said structure including an X axis rotatable structure and a Y axis rotatable structure and a Z axis rotatable structure;
b) aiming said payload in a certain direction by changing the aim of the payload about said X axis and said Y axis and said axis, and
c) if, as a result of said aiming the payload in such direction, said Y axis approaches a zone of discontinuity, rotating said Z axis so that said zone of discontinuity is avoided.

11. The method as in claim 10 further including the step of:
d) if, as a result of said aiming the payload in such direction, a zone of discontinuity is imminent, tilting said payload on an axis orthogonal to the Y axis so that said zone of discontinuity is avoided.

12. The method as in claim 11 wherein any Z axis rotation of the payload is controllably reversed at some time when the direction of the aim of the payload is in a condition other than the condition of entering a zone of discontinuity.
